(19) United States
(12) Patent Application Publication
(10) Pub. No.: US 2016/0376738 A1
(43) Pub. Date: Dec. 29, 2016

(54) ELECTROPROCESSED BIOFUNCTIONAL COMPOSITION

(71) Applicants: AMOGREENTECH CO., LTD., Gimpo-si (KR); Kollodis BioSciences, Inc., North Augusta, SC (US)

(72) Inventors: Chan Kim, Nam-gu (KR); Kyuwon Baek, Seoul (KR); Sangjae Lee, Seoul (KR); Bongjin Hong, Pohang-si (KR)

(21) Appl. No.: 15/173,342

(22) Filed: Jun. 3, 2016

Related U.S. Application Data
(60) Provisional application No. 62/171,815, filed on Jun. 5, 2015.

(51) Int. Cl. D04H 1/728; A01N 37/46; A01N 25/10

(52) U.S. Cl. CPC D04H 1/728; A01N 25/10; A01N 37/46

(57) ABSTRACT

Described are methods for preparing an electroprocessed composition functionalized with bioactive materials and the use of the electroprocessed composition, including use as an engineered extracellular microenvironment and its use in forming three-dimensional matrix for biological application. The electroprocessed composition may also be combined with other molecules in order to deliver substances to the site of application or implantation of the electroprocessed composition.

### CROSS-REFERENCE TO RELATED APPLICATION

This application claims the benefit of U.S. Provisional Patent Application Ser. No. 62/171,815, filed Jun. 5, 2015, the disclosure of which is hereby incorporated herein in its entirety by this reference.

### TECHNICAL FIELD

The application relates to a method for preparing electroprocessed composition functionalized with bioactive materials, the electroprocessed composition itself, and methods of using the electroprocessed composition.

### BACKGROUND

Nanofiber has a huge potential for wide applications in the water, air, medical and commodity industries. Typical examples of medical application include artificial organ components, tissue engineering, implant material, drug delivery, wound dressing, and medical textile materials. For additional applications, protective materials or coating include sound absorption materials, protective clothing against chemical and biological warfare agents, and sensor applications for detecting chemical agents.

However, improvements and new functionalities are desired in order to enhance the properties of nanofibers and its wide application.

Several methods have been proposed to improve or add desired functionalities to nanofiber.

### Chemical Modification of Nanofiber Surface

Many attempts have been made for the surface modification of nanofiber or incorporation of functional materials to nanofiber. For example, hydrophilic modification of hydrophobic PVDF nanofiber by grafting a hydrophilic polymer such as epoxide-containing polymer or polyethylene glycol to a PVDF nanofiber in order to improve its mechanical strength and hydrophilicity has been suggested.

While chemical modification permanently adds hydrophilic groups to the PVDF membrane by covalent bonding, the nanofibers created by such modification have disadvantages. The modification reaction often has a low yield and poor reproducibility. In addition, many times, toxic chemicals are used in the modification reaction. Still further, the process may be lengthy and costly.

An alternative approach to improving the functionality of a nanofiber, for example, PVDF membranes, is to blend another polymer with hydrophobic PVDF. Components that can be blended with PVDF include cellulose acetate, sulfonated polysulfone, glycerol monoacetate, glycerol diacetate, glycerol triacetate, and sulfonated polyetherketone. (See U.S. Pat. No. 6,024,872 and U.S. Pat. No. 8,931,647, the contents of each of which are incorporated herein by this reference.)

The polymer blend approach has a lower cost and higher efficiency than chemical modification. However, the polymer blend approach has some drawbacks. Because there is no covalent bonding between the PVDF and the hydrophilic components, it is often found that membrane performance deteriorates with time due to a gradual loss of hydrophilic components from the membrane matrix. (See, U.S. Pat. No. 9,309,367 and U.S. Publication No. 2015/0210816, the contents of each of which are incorporated herein by this reference.)

Another method that has been suggested is surface coating. For example, a hydrophobic PVDF membrane may be coated with a water-insoluble vinyl alcohol-vinyl acetate copolymer or water soluble polymer such as polyvinylpyrolidone (PVP). (See, U.S. Pat. Nos. 5,151,193, 5,834,107 and 4,399,035, the contents of each of which are incorporated herein by this reference, where PVP is used as an additive to fabricate a PVDF membrane.) The coating layer, however, is more vulnerable to free chlorine attack than PVDF. Therefore, after frequent exposure to a cleaning reagent containing free chlorine, such as bleach, the hydrophilic-coated membrane becomes hydrophobic.

### BRIEF SUMMARY

Disclosed is an electroprocessed functional composition, the functional composition comprising a structural component and a functional component.

The structural component is an electroprocessable polymer. The polymer may be, synthetic or naturally occurring, a hydrophilic or hydrophobic polymer.

The functional component is DOPA™-containing material, derived from a naturally occurring polymer or synthetic polymer. DOPA™-containing material can be selected from polydopamine homopolymer or its copolymer as synthetic material, mussel adhesive protein, or mixture of polydopamine and mussel adhesive protein.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 illustrates the photographs of chemically cross-linked MAPTRIX® ECM hydrogel with 8 ARM-SG-20K.

FIG. 2 indicates the kinetic of dopamine in a weak acidic condition is very low.

FIG. 3 shows scanning electron microscope (SEM) images of representative PVDF fibers of the invention electrospun from PVDF/MAPTRIX® and PVDF/polydopamine solution.

FIG. 4, Columns A and B, show water droplets formed on the nanofiber membrane of PVDF alone and PVDF functionalized with DOPA™-containing material, respectively.

FIGS. 5A and 5B show the DSC curves of pure PVDF and functionalized PVDF membrane.

FIG. 6, Panels A-D, are petri dishes showing reduction measurements against gram-positive (Staphylococcus aureus) bacteria. Panel A is the control; Panel B is 5 mg; Panel C is 10 mg; and Panel D is 20 mg.

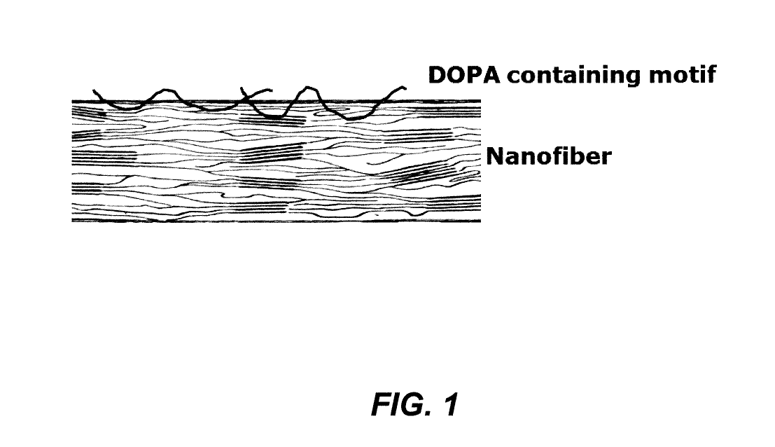

### DETAILED DESCRIPTION

Described is an electroprocessable functional composition comprising a structural component and at least one or more functional components, wherein the structural component is electroprocessable, and the functional component is a DOPA™-containing motif

### Hydrophilic Polymer as a Structural Component

Any hydrophilic polymer can be used in the disclosure. For example, an acrylic resin, a methacrylic resin, a polyvinyl acetal resin, a polyurethane resin, a polyurea resin, a polyimide resin, a polyamide resin, an epoxy resin, a polystyrene resin, a novolac type phenolic resin, a polyester resin, a synthesis rubber and a natural rubber can be used for the disclosure. The hydrophilic polymer may be a copolymer and the copolymer may be a random copolymer.

### Hydrophilic Polymer as a Structural Component

Hydrophilic polymers useful for electroprocessing composition in the disclosure include synthetic biocompatible polymers including polyethylene glycol polymers and polyethylene oxide polymers.

In one embodiment, the polyethylene glycol has a molecular weight of from about 40 kDa to about 300 kDa. In one embodiment, the fiber includes about 35 wt % mussel adhesive protein and about 65 wt % polyethylene oxide.

### Hydrophobic Polymer as a Structural Component

Any hydrophobic polymer can be used herein. A suitable hydrophobic polymer is a polyacrylate, polyolefin, silicone adhesive, natural or synthetically derived rubber base or a polyvinyl ether or a blend thereof Preferably, the hydrophobic polymer is a PVDF, PES,

### Functional Component

Any 3,4-dihydroxy-L-phenylalanine (DOPA) or its derivative such as dopamine-containing material can be used for the disclosure. For example, synthetic polydopamine or mussel adhesive protein, naturally occurring or recombinantly expressed, can be used herein.

Polydopamine formed by the oxidation of dopamine has several advantages for this disclosure, as seen with mussel adhesive protein. For example, it can adhere to most surfaces of inorganic and organic materials, including superhydrophobic surfaces such as TEFLON® or PVDF (polyvinylidene fluoride). Another feature of polydopamine is in its chemical structure that incorporates functional groups such as catechol, amine, and imine. (See Yanlan Liu, et al., Chem. Rev. 2014, 114:5057-5115, “Polydopamine and Its Derivative Materials: Synthesis and Promising Applications in Energy, Environmental, and Biomedical Fields”; Haeshin Lee, et al., Science 318:426 (2007), “Mussel-Inspired Surface Chemistry for Multifunctional Coatings.”)

Any suitable mussel adhesive protein as a functional component may be used as the functional component in the disclosure. The mussel adhesive proteins are commercially available materials and are obtained from synthetic or natural sources. Examples of commercially available proteins include MAPTRIC® ECM marketed by Kollodis BioSciences, Inc. (North Augusta, S.C.). Preferably, MAPTRIX® is used in the disclosure.

As used herein “MAPTRIX®” refers to a recombinant mussel adhesive protein selected from FP-1, FP-2, FP-3, FP-4, FP-5, FP-6 and its fragment or fusion of each mussel adhesive protein. The FP-1 comprises an amino acid sequence of SEQ ID NOS:1-3. The FP-2 comprises SEQ ID NO:4, the FP-3 comprises SEQ ID NOS:5-8, the FP-4 comprises SEQ ID NO:9, the FP-5 comprises SEQ ID NOS:10-13, and the FP-6 comprises SEQ ID NO:14.

MAPTRIX® is a chimeric polypeptide comprising a mussel adhesive protein and a functional peptide coupled to the mussel adhesive protein. The functional peptide can be synthetic or naturally occurring protein-derived. More preferably, MAPTRIX® ECM is used for the disclosure.

The MAPTRIX® ECM is a mussel adhesive protein recombinantly functionalized with bioactive peptides, a fusion protein comprising a first peptide of mussel foot protein FP-5 (SEQ ID NO:5) that is selected from the group consisting of SEQ ID NOS:10-13 and a second peptide of at least one selected from the group consisting of mussel FP-1 selected from the group consisting of SEQ ID NOS:1-3, mussel FP-2 (SEQ ID NO:4), mussel FP-3 selected from the group consisting of SEQ ID NOS:6-8, mussel FP-4 (SEQ ID NO:9), mussel FP-6 (SEQ ID NO:14) and fragment thereof, and the second peptide is linked to C-terminus, N-terminus or C- and N-terminus of the FP-5. Preferably, the second peptide is the FP-1 comprising an amino acid sequence of SEQ ID NO:1.

Mussel adhesive protein useful in electroprocessing the composition in the invention is a chimeric polypeptide comprising a mussel adhesive protein and a biofunctional peptide coupled to the mussel adhesive protein. The biofunctional peptide is linked to C-terminus, N-terminus or C- and N-terminus of the mussel adhesive protein. The biofunctional peptide useful in making the fibers of the invention an ECM mimic is derived from a cell binding domain or heparin binding domain of fibronectin. In one embodiment, the biofunctional peptide is a peptide having an amino acid sequence of SEQ ID NO:4. The examples of cell binding domain of fibronectin are RGD (SEQ ID NO:22) and GRGDSP (SEQ ID NO:23). The biofunctional peptide useful in making the fibers of the invention an ECM mimic is derived from laminin, collagen or vitronectin. The biofunctional peptide is selected from the group consisting of peptides comprising an amino acid sequence of SEQ ID NOS:22-28. The biofunctional peptide is a peptide having an amino acid sequence of RGD (SEQ ID NO:22), a peptide having an amino acid sequence of GRGDSP (SEQ ID NO:23), a peptide having an amino acid sequence of PHSRN-RGDSP (SEQ ID NO:27), a peptide having an amino acid sequence of SPPRRARVT (SEQ ID NO:24), and a peptide having an amino acid sequence of KNNQKSEPLIGRKKT (SEQ ID NO:26).

In another embodiment, the biofunctional peptide useful in making an antimicrobial nanofiber membrane can be selected from KLWKKWAKKWLKLWKA (SEQ ID NO:27), FALALKALKKL (SEQ ID NO:28), ILRWPWWPWRRK (SEQ ID NO:29), AKRHHGYKRKFH (SEQ ID NO:30), KWKLFKKIGAVLKVL (SEQ ID NO:31), LVKLVAGIKKFLKWK (SEQ ID NO:32), IWSILAPLGTTLVKLVAGIGQQKRK (SEQ ID NO:33), GIGAVLKVLTTGLPALISWI (SEQ ID NO:34), SWLSKTAKKGAVLKVL (SEQ ID NO:35), KKLFKKILKYL (SEQ ID NO:36), GLKKLISWIKRAAQQG (SEQ ID NO:37), GWLKKIGKKIERVGQHTRDATIQGLG IAQQAANVAATAR (SEQ ID NO:38), and RRWWCRC (SEQ ID NO:39).

The mussel adhesive protein-based fiber of the invention includes a hydrophilic polymer to facilitate production of the fiber by electrospinning. Hydrophilic polymers useful in making the fiber of the invention include synthetic biocompatible polymers including polyethylene glycol polymers and polyethylene oxide polymers. In one embodiment, the polyethylene oxide or polyethylene glycol has a molecular weight of from about 30 kDa to about 300 kDa. In one embodiment, the fiber includes about 30 wt % mussel adhesive protein and about 70 wt % polyethylene oxide. In another embodiment, the fiber includes about 30 wt % mussel adhesive protein and about 70 wt % polyethylene glycol.

The electroprocessing can be any one selected from among electrospinning, electrospray, electroblown spinning, centrifugal electrospinning, flash-electrospinning, bubble electrospinning, melt electrospinning, and needleless electrospinning.

Hydrophilic conversion of a superhydrophobic surface was easily achieved by polydopamine, a functional polymeric mimic of the mussel adhesive protein Mytilus edulis foot protein-5 (Mefp-5). This superhydrophobic surface modification is compatible with widely used soft-lithographic techniques such as MIMIC to enable facile functionalization of superhydrophobic surfaces. The modified surface remained superhydrophobic but showed high water adhesion properties. A general approach to determine surface energy of the modified superhydrophobic surface was demonstrated. Finally, the modified superhydrophobic surface can be used as a part of a water-capturing device that mimics the mechanism of collecting water shown in the cuticle of the Namib desert beetle. This new superhydrophobic surface chemistry can be applied to potentially advance superhydrophobic surface engineering for a variety of applications.

Fouling occurs when certain impurities in water deposit on a membrane's surface or in its internal pore structure. This deposition leads to a dramatic reduction in permeate flux, requiring periodic chemical cleanings resulting in increased operating costs and decreased membrane life. New membrane materials and treatments are researched to help reduce foulant adhesion. Recently, very thin coatings of polydopamine, polydopamine+PEG (Freeman et al. U.S. Pat. No. 8,017,050 issued Sep. 13, 2011) and hydroquinone, catechol, or mixtures of hydroquinone, catechol, and/or polydopamine (Freeman et al., non-provisional patent application Ser. No. 12/939,764) onto the surface of commercial microfiltration, ultrafiltration, nanofiltration, and reverse osmosis membranes have shown significant reduction in membrane fouling. A multi-year research program at the University of Texas resulted in filing of the above patents and patent applications in addition to a graduate thesis for Dr. Bryan McCloskey. Key findings of his research are published in a paper McCloskey et al., “Influence of Polydopamine Deposition Conditions on Pure Water Flux and Foulant Adhesion Resistance of Reverse Osmosis, Ultrafiltration, and Microfiltration Membranes,” Polymer 51:3472-3485 (2010). In addition, more work on the subject matter was pursued by Z. Y. Xi and published as “A facile method of surface modification for hydrophobic polymer membranes based on the adhesive behavior of poly(DOPA) and poly(dopamine),” Journal of Membrane Science (2009). Details for the above works are incorporated herein as reference. It was demonstrated in previous works that in addition to antifouling properties, these thin polymeric coatings are extremely hydrophilic and permeable to water; however, these works either did not develop or disclosed details related to 1) improvements in membrane selectivity for ion rejection and their implications; 2) capability to effectively utilize the active chemistry use during the coating of a polydopamine layer; 3) its storage, repeated and more effective use and safe disposal; and 4) effective maintainability and serviceability of the coated membranes. Advanced Hydro Inc. undertook the commercialization of the technology of the issued patent U.S. Pat. No. 8,017,050, the contents of which is incorporated herein by this reference and, through additional research, developed claims embodied in this patent application. United States Patent Publication No. 2014/0054221, the contents of each of which is incorporated herein by this reference.

### Preparation of Electroprocessing Solution Containing a Hydrophobic Polymer

A hydrophobic polymer (e.g., PVdF) is dissolved in a suitable solvent at a concentration at which it can be spun, thereby preparing a spinning solution. The content of the polymer material (PVdF) in the spinning solution is preferably 5-90 wt %. If the content of the polymer material in the spinning solution is less than 5 wt % when the spinning solution is electrospun, it will form beads rather than forming nanofibers, thus making it difficult to manufacture a membrane. On the other hand, if the content of the polymer material is more than 90%, it will be difficult to form fibers, because the viscosity of the spinning solution is high. Accordingly, although the preparation of the spinning solution is not specifically limited, it is preferable that the concentration of the polymer in the spinning solution be set at a concentration at which a fibrous structure can be easily formed, thereby controlling the morphology of fibers.

### Electroprocessing Procedure

The electroprocessing solution is transferred to a spin pack using a metering pump, and then electrospun by applying high voltage to the spin pack using a high voltage controller. Herein, the voltage used is adjustable within the range of 0.5 to 100 kV, and as a current collector plate, an electrically conductive metal or release paper may be used and it may be grounded or negatively charged before use. The current collector plate is preferably used together with a suction collector attached thereto in order to facilitate bundling of fibers during spinning.

In the electrospinning, the interval between the spin pack and the current collector plate is preferably controlled to 5-50 cm, and the spinning solution is discharged at a rate of 0.0001-5 cc/hole·per minute using a metering pump. Also, the electrospinning is preferably carried out at a relative humidity of 30-80% in a chamber whose temperature and humidity can be controlled. The nanofiber web spun as described above has an average fiber diameter of 50-1,000 nm.

The spinning process can be carried out using, in addition to electrospinning, electrospray, electroblown spinning, centrifugal electrospinning, flash-electrospinning, bubble electrospinning, melt electrospinning, or needleless electrospinning.

E. coli-based protein expression system was commercialized recently to produce a variety of mussel adhesive proteins including FP-151 in an efficient way (see International Publication No. WO 2011/115420), and the mussel adhesive proteins are commercially available under trademark MAPTRIX® marketed by Kollodis BioSciences, Inc. The method for preparation of bioactive mussel adhesive proteins are fully described in International Publication No. WO/2011/115420, which is hereby incorporated by reference for all purposes as if fully set forth herein.

### EXAMPLES

### Example 1

### Polydopamine Precursor Preparation

### Characterization of the Dopamine Polymerization by UV-Vis Spectra

The reactivity of dopamine was measured at room temperature using UV-vis spectroscopy (U-200A, Shanghai Spectrum Instruments Co., Ltd, shanghai, China) at the wavelengths from 250 to 600 nm.

The DA·HCl concentration was 1 mg/ml in all experiments. For the UV spectroscopy measurements, the samples were prepared by 1:19 (v/v) dilution of the DA solution with distilled water. In the “pH-induced” control experiment, 2 mg/ml DA·HCl was added into the Tris-HCl buffer (pH 8.5).

To investigate the DA polymerization in weak acidic, neutral and weak alkaline aqueous media, 2 mg/ml DA and 1.2 mg/ml AP (the molar ratio of AP to DA was 1:2) were added into the buffer solutions of pH 5.5 (Disodium hydrogen phosphate-citric acid buffer), pH 7.0 (Disodium hydrogen phosphate-citric acid buffer) and pH 8.5 (Tris-HCl buffer) for a 2-hour polymerization. For the UV spectroscopy measurements, the operation was the same as above. The experiments for sodium periodate and potassium chlorate-induced DA polymerization was the same as for AP.

### Example 2

### Electroprocessing of Functional Composition

### a) Composition: MAPTRIX®/PEO Nanofiber

Poly(ethylene oxide) (PEO) with an average molecular weight of 600,000 was from Sigma (St. Louis, Mo., USA). 4 wt % mussel adhesive protein (MAPTRIX®, Kollodis BioSciences, Inc. MA) solutions and 4 wt % PEO solutions were prepared separately by dissolving mussel adhesive protein and PEO in distilled water, followed by filtration through a 5 syringe filter to remove remaining insoluble materials. The mussel adhesive protein and PEO solutions of different proportions were then mixed to obtain mixtures with weight ratios of mussel adhesive protein to PEO in the range 40:60-90:10, and the resultant mixtures were stirred for at least 30 minutes. Solutions containing 2 wt % urea were mixed with mussel adhesive protein-PEO blend solutions, and the mixtures were stirred for an additional 30 minutes and filtered to remove remaining insoluble materials before use in electrospinning. Electrospinning was performed with a steel capillary tube with a 1.5 mm inside diameter tip mounted on an adjustable, electrically insulated stand as described in H -J. Jin et al., Biomacromolecules 3 (2002), pp. 1233-1239. Briefly, a DC voltage of 15-22 kV with low current output (High DC power supply, Nano NC Corp., Ansan, Korea) was applied between the syringe tip and a cylindrical collector. The typical distance between the syringe tip and the grounded collector was 15-20 cm. The electrospinning solution inside the syringe was charged with a positive voltage by dipping a platinum wire into the solution from a positive lead; the cylindrical collector was grounded.

### b) Composition: MAPTRIX®/HA/PEO

Mussel adhesive protein, hyaluronic acid (HA), and polyethylene oxide (PEO) powder were dissolved in 0.1 N NaOH at concentrations of 5, 2, and 4 wt %, respectively. Hyaluronic acid solution was then added into the PEO/NaOH solutions at a concentration of 1.0% (w/v) and dissolved using a vortex mixer (Vortex-genie2, Scientific Industries, Inc.) for 20 minutes until the solution became clear. The MAPTRIX®/HA/PEO blend solutions with different weight ratios from 1/1/1 to 1/1/3 were prepared for electrospinning. The same electrospinning conditions were applied.

### c) Composition: PVDF/MAPTRIX®

MAPTRIX® solution was prepared by dissolving mussel adhesive protein (10 mg) in 1 mL distilled water and followed by the addition of dimethyl acetamide (DMAc) to the MAPTRIX® solution.

PVDF (MW: 400,000 da) was dissolved in DMAc at 80° C. with magnetic stirring for 12 hours to form a 20 wt % (w/v) electrospinning solution. The MAPTRIX® solution (1 mL) was added to the PVDF solution (4 mL) to get 5 mL of electroprocessable functional composition.

The electroprocessable composition was transferred to a spin pack using a metering pump, and then electrospun by applying high voltage to the spin pack using a high voltage controller. The voltage used here was adjustable within the range of 19 to 20 kV, and as a collector plate, an electrically conductive metal was used.

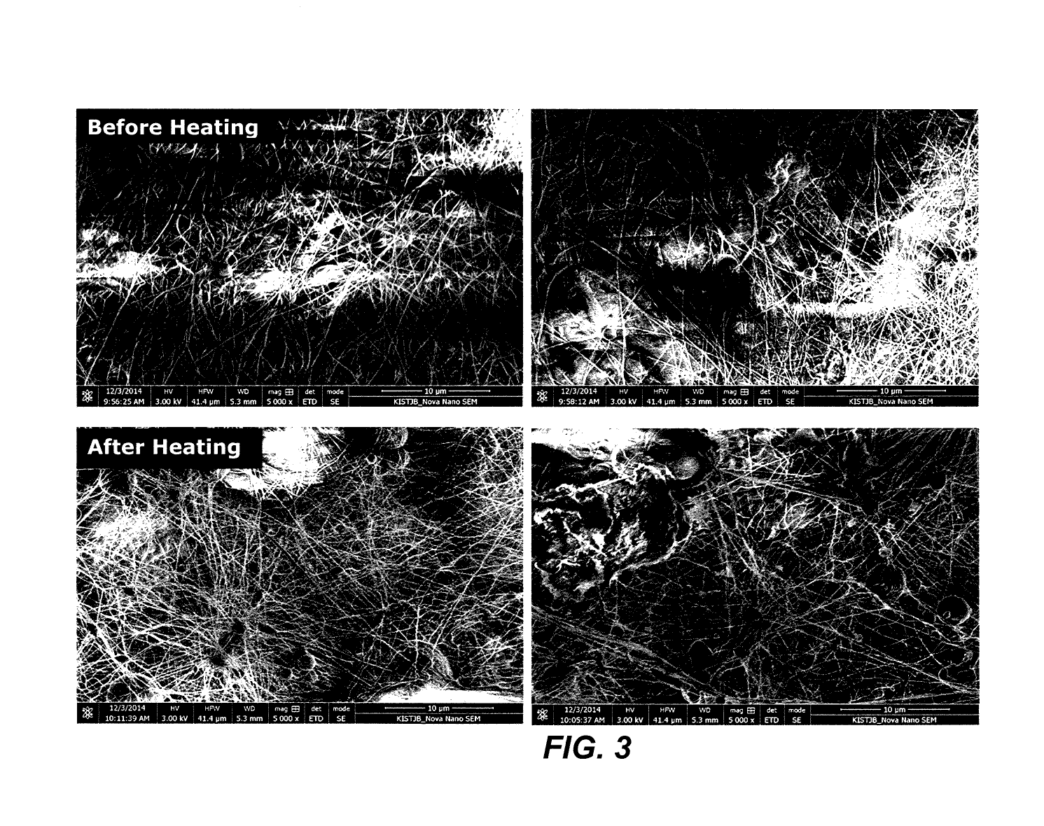

FIG. 3 shows scanning electron microscope (SEM) images of representative PVDF fibers of the invention electrospun from PVDF/MAPTRIX® and PVDF/polydopamine solution.

### d) Composition: PVDF/Polydopamine Precursor

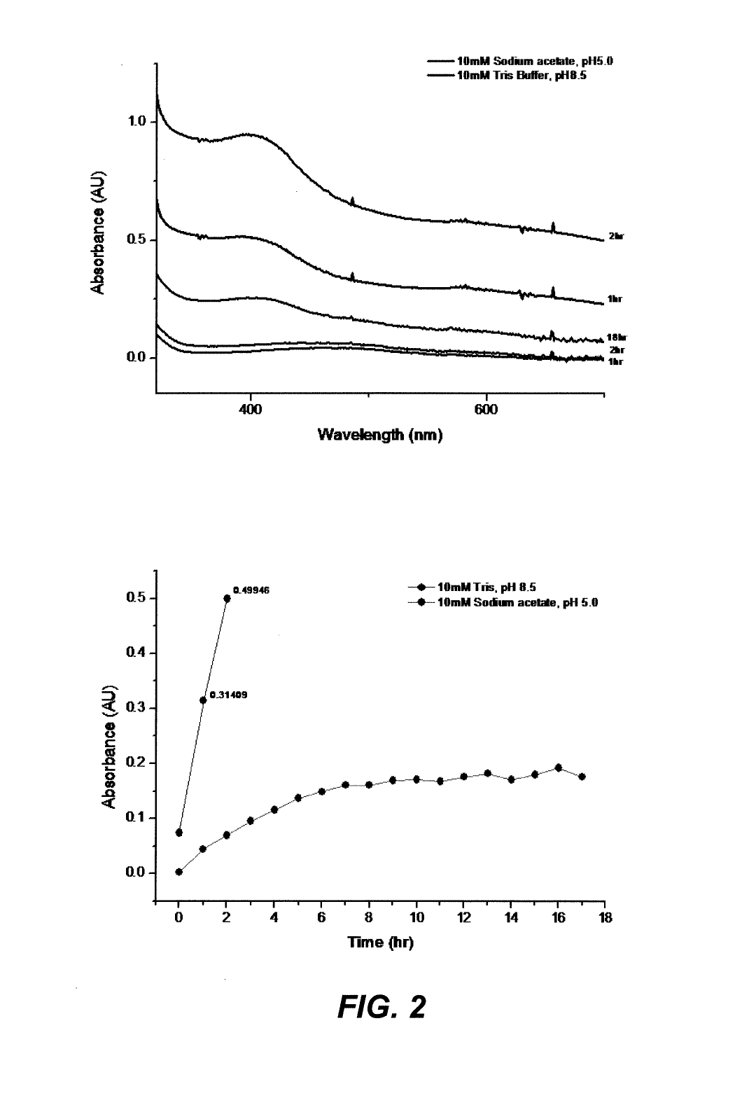

21 mg of dopamine was dissolved in distilled water (1 mL) and very slow oxidation reaction was allowed for 3 to 6 hours to form a precursor. As described in FIG. 2, the kinetic of dopamine in a weak acidic condition was very low.

| Code | Precursor | Precursor treatment | E-spin solution |
|---|---|---|---|
| 1 | M2 mg | MD91-0.5 H | PVDF 4 mL + Precursor 1 mL |
| 2 | M2 mg | MD82-0.5 H | PVDF 4 mL + Precursor 1 mL |
| 3 | M2 mg | MD91-0.5 H | PVDF 4 mL + Precursor 1 mL |
| 4 | D21 mg | DA91-3 H | PVDF 4 mL + Precursor 1 mL |
| 5 | D21 mg | DA82-3 H | PVDF 4 mL + Precursor 1 mL |
| 6 | D21 mg | DA73-3 H | PVDF 4 mL + Precursor 1 mL |
| 7 | D21 mg | DA91-6 H | PVDF 4 mL + Precursor 1 mL |
| 8 | D21 mg | DA82-6 H | PVDF 4 mL + Precursor 1 mL |
| 9 | D21 mg | DA73-6 H | PVDF 4 mL + Precursor 1 mL |

Note:
Precursor: M indicates mussel adhesive protein and D indicates dopamine
Precursor treatment: MD indicates DMAc/water as a solvent and DA indicates acetone/water as a solvent to make a precursor and H means the reaction time.

### Example 3

### Surface Characterization of Electroprocessed Composition

PEO/MAPTRIX® composition makes hydrophilic nanofiber membrane and thus its contact angle was measured. The surface contact angles were measured on a Drop Shape Analysis System (DSA100) (KRUSS, Germany). Deionized water was dropped onto the sample from a needle on a microsyringe during the test. A picture of the drop was captured after the drop set onto the sample. The contact angle was calculated by the software through analyzing the shape of the drop. The contact angle was an average of 5 points.

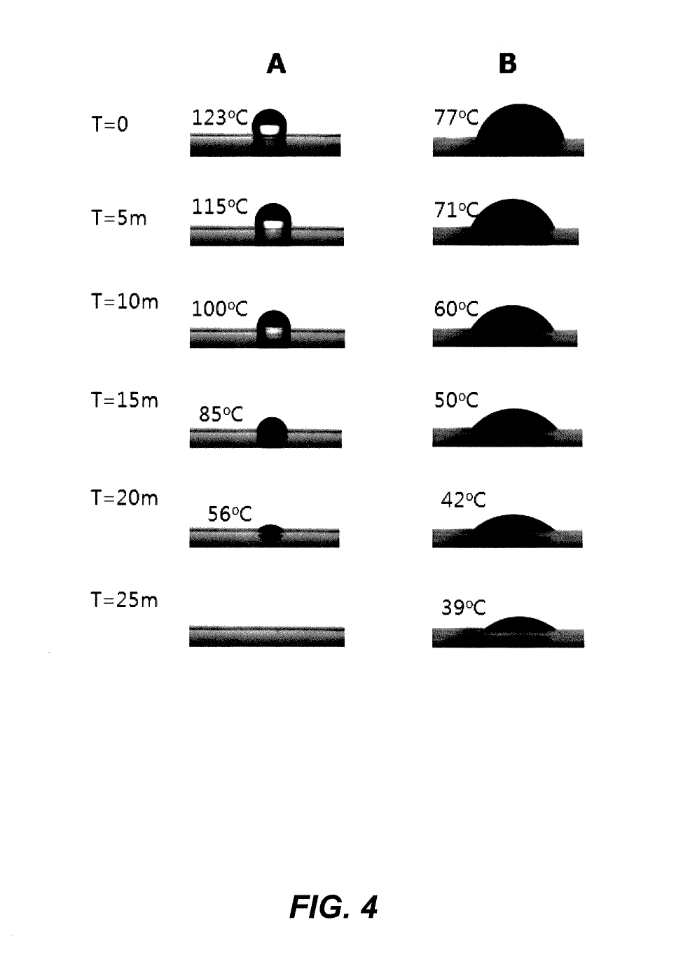

FIG. 4, Columns A and B, show water droplets formed on the nanofiber membrane of PVDF alone and PVDF functionalized with DOPA™-containing material, respectively. The surface contact angle of the pure PVDF nanofiber membrane is 120°, in agreement with the strong hydrophobicity of PVDF material to water. A significant decrease in the contact angle on the functionalized PVDF membrane is ascribed to the presence of a hydrophilic group, such as —COOH, —OH, NH2.

### Example 4

### Thermal Analysis

The melting temperature and crystallization temperature of the PVDF membranes was characterized by differential scanning calorimeter (Perkin-Elmer DSC-7, Wellesley, Mass., USA). The heating rate was set to 10° C./minute.

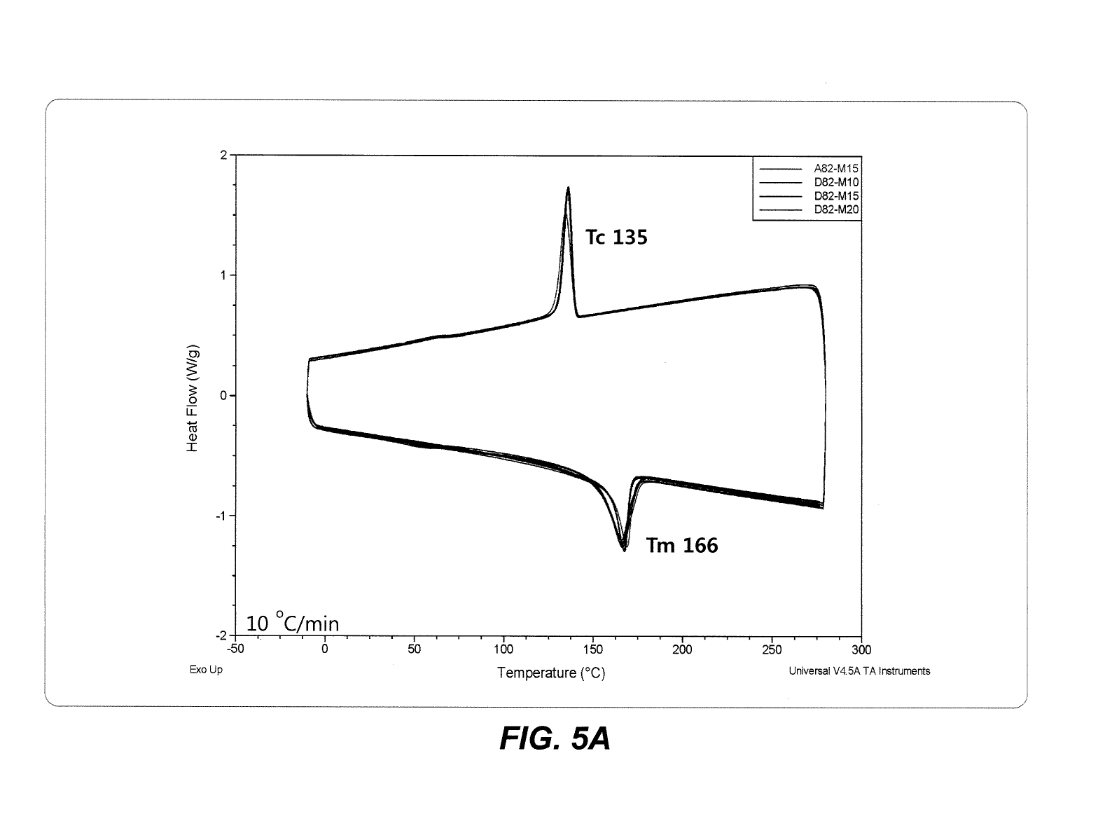

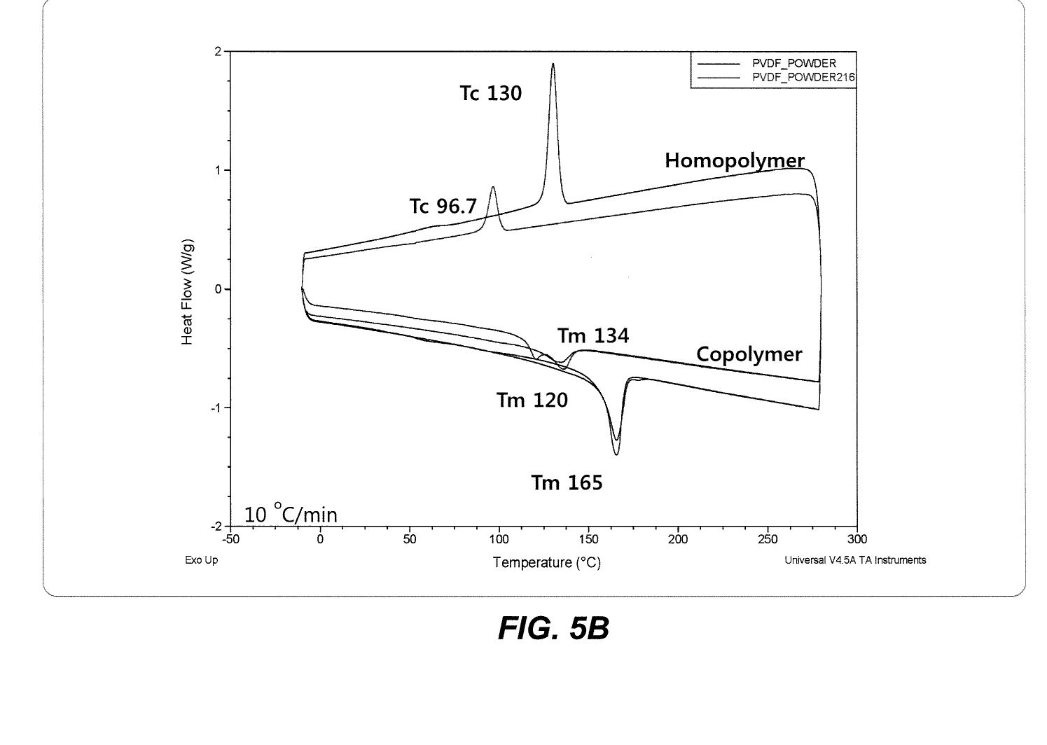

FIG. 5 shows the DSC curves of pure PVDF and functionalized PVDF membrane. Both samples have melting peak at 165° C. Functionalization of PVD did not affect melting temperature but a slight change in crystallization temperature was observed even though the difference was small, indicating the crystallization behavior was not influenced by the presence of precursors such as MAPTRIX® or polydopamine precursor.

### Example 5

### Preparation of Antimicrobial Nanofiber and Antimicrobial Assay

A composition comprising PVDF and mussel adhesive protein functionalized with antimicrobial peptide was prepared for electroprocessing. The composition was prepared and electroprocessed as described in EXAMPLE 1. The electrospun composition is an antimicrobial nanofiber membrane.

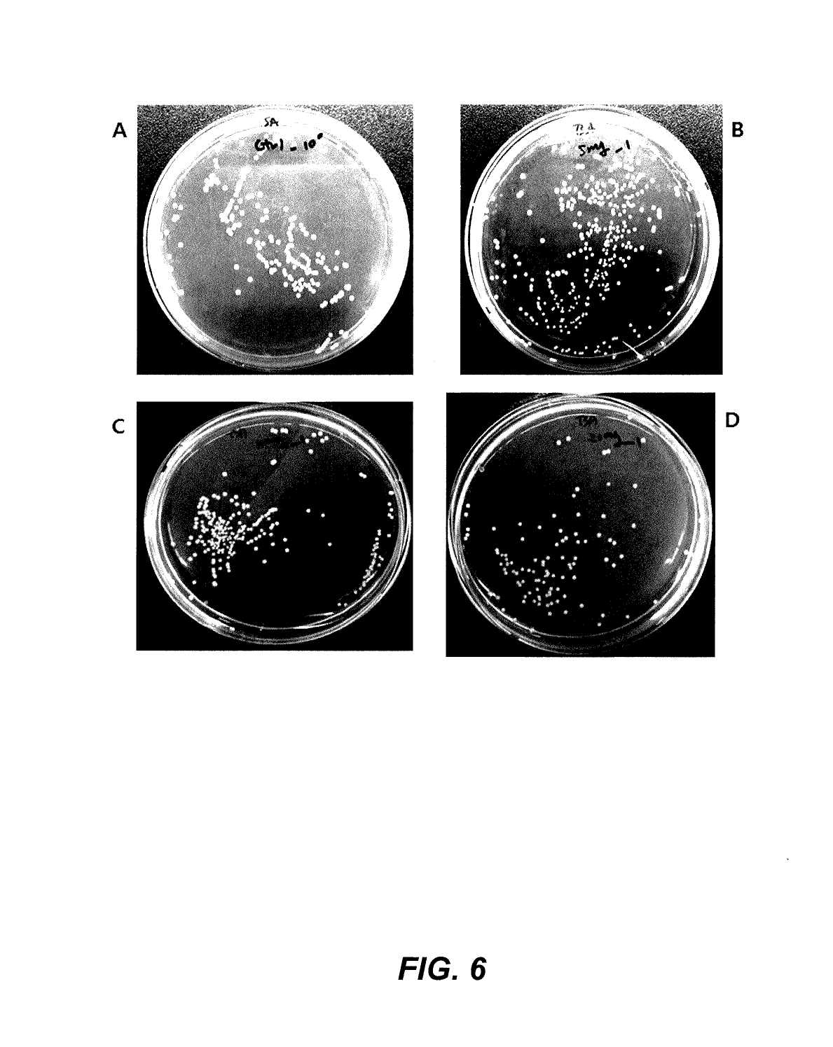

One gram of antimicrobial nanofiber membrane (1 mm×1 mm) and 5 mL of a liter of 4.6×105 CFU/ml of Staphylococcus aureus is added to 70 ml test tube containing phosphate buffer and was then placed on a Burrell Wrist Action Shaker for one hour. Reduction measurement indicates that the nanomembrane was effective against the gram-positive (Staphylococcus aureus) bacteria even though the reduction percentage was about 50% as seen in FIG. 6. An electroprocessing of antimicrobial composition with optimal concentration of antimicrobial mussel adhesive protein can make its nanofiber membrane effective against the bacteria.

What is claimed is:

1. A method for preparing a electroprocessed composition functionalized with bioactive materials.

2. An electroprocessed composition functionalized with bioactive materials.

3. The electroprocessed composition of claim 2, which is combined with other molecules in order to deliver substances to an application site or implantation site of the electroprocessed composition.

4. A method of using an electroprocessed composition, the method comprising:
utilizing the electroprocessed composition as an engineered extracellular microenvironment, or
utilizing the electroprocessed composition in forming a three-dimensional matrix for a biological application.

5. The method according to claim 4, wherein the electroprocessed composition is utilized as an engineered extracellular microenvironment.

6. The method according to claim 4, wherein the electroprocessed composition is utilized in forming a three-dimensional matrix for a biological application.


SEQUENCE LISTING (39 sequences)

SEQ ID NO: 1 - protein, 10 aa, Artificial Sequence
  model peptide of the tandem repeat decapeptide derived from foot protein 1 (FP-1, Mytilus edulis)
AKPSYPPTYK

SEQ ID NO: 2 - protein, 20 aa, Artificial Sequence
  2 times repeated sequence derived from foot protein 1 (FP-1, Mytilus edulis)
AKPSYPPTYKAKPSYPPTYK

SEQ ID NO: 3 - protein, 60 aa, Artificial Sequence
  6 times repeated sequence derived from foot protein 1 (FP-1, Mytilus edulis)
AKPSYPPTYKAKPSYPPTYKAKPSYPPTYKAKPSYPPTYKAKPSYPPTYKAKPSYPPTYK

SEQ ID NO: 4 - protein, 39 aa, Artificial Sequence
  partial sequence of foot protein type 2 (FP-2, Mytilus californianus)
EVHACKPNPCKNNGRCYPDGKTGYKCKCVGGYSGPTCAC

SEQ ID NO: 5 - protein, 52 aa, Artificial Sequence
  Foot protein type 3 (FP-3, Mytilus edulis)
ADYYGPKYGPPRRYGGGNYNRYGGSRRYGGYKGWNNGWKRGRWGRKYYEFEF

SEQ ID NO: 6 - protein, 46 aa, Artificial Sequence
  Foot protein type 3 (FP-3, Mytilus galloprovincialis  mgfp-3A)
ADYYGPKYGPPRRYGGGNYNRYGRRYGGYKGWNNGWKRGRWGRKYY

SEQ ID NO: 7 - protein, 50 aa, Artificial Sequence
  Foot protein type 3 (FP-3, Mytilus edulis mefp-3F)
ADYYGPNYGPPRRYGGGNYNRYNGYGGGRRYGGYKGWNNGWNRGRRGKYW

SEQ ID NO: 8 - protein, 44 aa, Artificial Sequence
  Foot protein type 3 (FP-3, Mytilus californianus)
GAYKGPNYNYPWRYGGKYNGYKGYPRGYGWNKGWNKGRWGRKYY

SEQ ID NO: 9 - protein, 60 aa, Artificial Sequence
  partial sequence from foot protein type 4 (Mytilus californianus)
GHVHRHRVLHKHVHNHRVLHKHLHKHQVLHGHVHRHQVLHKHVHNHRVLHKHLHKHQVLH

SEQ ID NO: 10 - protein, 75 aa, Artificial Sequence
  Foot protein type5 (FP-5, Mytilus edulis)
SSEEYKGGYYPGNAYHYHSGGSYHGSGYHGGYKGKYYGKAKKYYYKYKNSGKYKYLKKARKYHRKGYKKYYGGSS

SEQ ID NO: 11 - protein, 76 aa, Artificial Sequence
  Foot protein 5 (FP-5, Mytilus edulis)
SSEEYKGGYYPGNTYHYHSGGSYHGSGYHGGYKGKYYGKAKKYYYKYKNSGKYKYLKKARKYHRKGYKKYYGGGSS

SEQ ID NO: 12 - protein, 71 aa, Artificial Sequence
  Foot protein 5 (FP-5, Mytilus coruscus)
YDDYSDGYYPGSAYNYPSGSHWHGHGYKGKYYGKGKKYYYKFKRTGKYKYLKKARKYHRKGYKKHYGGSSS

SEQ ID NO: 13 - protein, 76 aa, Artificial Sequence; identical to SEQ ID NO: 11
  mussel adhesive protein foot protein type5 from (Mytilus galloprovincialis)

SEQ ID NO: 14 - protein, 99 aa, Artificial Sequence
  mussel adhesive protein foot protein type 6
GGGNYRGYCSNKGCRSGYIFYDNRGFCKYGSSSYKYDCGNYAGCCLPRNPYGRVKYYCTKKYSCPDDFYYYNNKGYYYYNDKDYFNCGSYNGCCLRSGY

SEQ ID NO: 15 - protein, 194 aa, Artificial Sequence
  hybrid mussel adhesive protein (FP-151, MEFP-5 based)
AKPSYPPTYKAKPSYPPTYKAKPSYPPTYKAKPSYPPTYKAKPSYPPTYKAKPSYPPTYKSSEEYKGGYYPGNAYHYHSGGSYHGSGYHGGYKGKYYGKAKKYYYKYKNSGKYKYLKKARKYHRKGYKYYGGSSAKPSYPPTYKAKPSYPPTYKAKPSYPPTYKAKPSYPPTYKAKPSYPPTYKAKPSYPPTYK

SEQ ID NO: 16 - protein, 196 aa, Artificial Sequence
  hybrid mussel adhesive protein (FP-151, MGFP-5 based)
AKPSYPPTYKAKPSYPPTYKAKPSYPPTYKAKPSYPPTYKAKPSYPPTYKAKPSYPPTYKSSEEYKGGYYPGNTYHYHSGGSYHGSGYHGGYKGKYYGKAKKYYYKYKNSGKYKYLKKARKYHRKGYKKYYGGGSSAKPSYPPTYKAKPSYPPTYKAKPSYPPTYKAKPSYPPTYKAKPSYPPTYKAKPSYPPTYK

SEQ ID NO: 17 - protein, 192 aa, Artificial Sequence
  hybrid mussel adhesive protein (FP-151, MCFP-5 based)
AKPSYPPTYKAKPSYPPTYKAKPSYPPTYKAKPSYPPTYKAKPSYPPTYKAKPSYPPTYKYDGYSDGYYPGSAYNYPSGSHGYHGHGYKGKYYGKGKKYYYKYKRTGKYKYLKKARKYHRKGYKKYYGGGSSAKPSYPPTYKAKPSYPPTYKAKPSYPPTYKAKPSYPPTYKAKPSYPPTYKAKPSYPPTYK

SEQ ID NO: 18 - protein, 177 aa, Artificial Sequence
  hybrid mussel adhesive protein (FP-131)
AKPSYPPTYKAKPSYPPTYKAKPSYPPTYKAKPSYPPTYKAKPSYPPTYKAKPSYPPTYKGCRADYYGPKYGPPRRYGGGNYNRYGGSRRYGGYKGWNNGWKRGRWGRKYYEFEFAKPSYPPTYKAKPSYPPTYKAKPSYPPTYKAKPSYPPTYKAKPSYPPTYKAKPSYPPTYKKL

SEQ ID NO: 19 - protein, 180 aa, Artificial Sequence
  hybrid mussel adhesive protein (FP-251)
MEVHACKPNPCKNNGRCYPDGKTGYKCKCVGGYSGPTCACSSEEYKGGYYPGNSNHYHSGGSYHGSGYHGGYKGKYYGKAKKYYYKYKNSGKYKYLKKARKYHRKGYKKYYGGSSEFEFAKPSYPPTYKAKPSYPPTYKAKPSYPPTYKAKPSYPPTYKAKPSYPPTYKAKPSYPPTYKK

SEQ ID NO: 20 - protein, 182 aa, Artificial Sequence
  hybrid mussel adhesive protein (FP-353)
GCRADYYGPKYGPPRRYGGGNYNRYGGSRRYGGYKGWNNGWKRGRWGRKYYEFEFYDGYSDGYYPGSAYNYPSGSHGYHGHGYKGKYYGKGKKYYYKYKRTGKYKYLKKARKYHRKGYKKYYGGGSSGCRADYYGPKYGPPRRYGGGNYNRYGGSRRYGGYKGWNNGWKRGRWGRKYYEFEF

SEQ ID NO: 21 - protein, 309 aa, Artificial Sequence
  hybrid mussel adhesive protein (FP-13151)
AKPSYPPTYKAKPSYPPTYKAKPSYPPTYKAKPSYPPTYKAKPSYPPTYKAKPSYPPTYKGCRADYYGPKYGPPRRYGGGNYNRYGGSRRYGGYKGWNNGWKRGRWGRKYYEFEFAKPSYPPTYKAKPSYPPTYKAKPSYPPTYKAKPSYPPTYKAKPSYPPTYKAKPSYPPTYKKLYDGYSDGYYPGSAYNYPSGSHGYHGHGYKGKYYGKGKKYYYKYKRTGKYKYLKKARKYHRKGYKKYYGGGSSAKPSYPPTYKAKPSYPPTYKAKPSYPPTYKAKPSYPPTYKAKPSYPPTYKAKPSYPPTYK

SEQ ID NO: 22 - protein, 3 aa, Artificial Sequence
  Fibronectin derived peptide (RGD)
RGD

SEQ ID NO: 23 - protein, 6 aa, Artificial Sequence
  Fibronectin derived peptide (GRGDSP)
GRGDSP

SEQ ID NO: 24 - protein, 9 aa, Artificial Sequence
  Fibronectin derived peptide (SPPRRARVT)
SPPRRARVT

SEQ ID NO: 25 - protein, 8 aa, Artificial Sequence
  laminin derived peptide (WQPPRARI)
WQPPRARI

SEQ ID NO: 26 - protein, 15 aa, Artificial Sequence
  laminin derived peptide (KNNQKSEPLIGRKKT)
KNNQKSEPLIGRKKT

SEQ ID NO: 27 - protein, 16 aa, Artificial Sequence
  Anti-microbacterial peptide (KLWKKWAKKWLKLWKA)
KLWKKWAKKWLKLWKA

SEQ ID NO: 28 - protein, 11 aa, Artificial Sequence
  Anti-microbacterial peptide (FALALKALKKL)
FALALKALKKL

SEQ ID NO: 29 - protein, 12 aa, Artificial Sequence
  Anti-microbacterial peptide (ILRWPWWPWRRK)
ILRWPWWPWRRK

SEQ ID NO: 30 - protein, 12 aa, Artificial Sequence
  Anti-microbacterial peptide (AKRHHGYKRKFH)
AKRHHGYKRKFH

SEQ ID NO: 31 - protein, 15 aa, Artificial Sequence
  Anti-microbacterial peptide (KWKLFKKIGAVLKVL)
KWKLFKKIGAVLKVL

SEQ ID NO: 32 - protein, 15 aa, Artificial Sequence
  Anti-microbacterial peptide (LVKLVAGIKKFLKWK)
LVKLVAGIKKFLKWK

SEQ ID NO: 33 - protein, 25 aa, Artificial Sequence
  Anti-microbacterial peptide (IWSILAPLGTTLVKLVAGIGQQKRK)
IWSILAPLGTTLVKLVAGIGQQKRK

SEQ ID NO: 34 - protein, 20 aa, Artificial Sequence
  Anti-microbacterial peptide (GIGAVLKVLTTGLPALISWI)
GIGAVLKVLTTGLPALISWI

SEQ ID NO: 35 - protein, 16 aa, Artificial Sequence
  Anti-microbacterial peptide (SWLSKTAKKGAVLKVL)
SWLSKTAKKGAVLKVL

SEQ ID NO: 36 - protein, 11 aa, Artificial Sequence
  Anti-microbacterial peptide (KKLFKKILKYL)
KKLFKKILKYL

SEQ ID NO: 37 - protein, 16 aa, Artificial Sequence
  Anti-microbacterial peptide (GLKKLISWIKRAAQQG)
GLKKLISWIKRAAQQG

SEQ ID NO: 38 - protein, 39 aa, Artificial Sequence
  Anti-microbacterial peptide
GWLKKIGKKIERVGQHTRDATIQGLGIAQQAANVAATAR

SEQ ID NO: 39 - protein, 7 aa, Artificial Sequence
  Anti-viral peptide (RRWWCRC)
RRWWCRC